(19) United States
(12) Patent Application Publication
(10) Pub. No.: US 2013/0243037 A1
(43) Pub. Date: Sep. 19, 2013

(54) MOUNTING APPARATUS FOR TEMPERATURE SENSOR

(71) Applicant: XU YANG, Shenzhen City (CN)

(72) Inventor: XU YANG, Shenzhen City (CN)

(21) Appl. No.: 13/653,458

(22) Filed: Oct. 17, 2012

(30) Foreign Application Priority Data
Mar. 15, 2012 (CN) 201210067650.9

(51) Int. Cl. G01K 1/14

(52) U.S. Cl. 374/208; 374/E01.018

(57) ABSTRACT

A mounting apparatus for mounting a temperature sensing apparatus includes a plate and a latch. The plate defines a mounting hole. A profile of the mounting hole is defined by a pair of long sides and a pair of short sides. The latch includes a mounting base and an elastic piece. The mounting base includes a pair of long edges and a pair of short edges. The mounting base can be secured in the mounting hole. The elastic piece secures a temperature sensing apparatus.

### BACKGROUND

1. Technical Field

The present disclosure relates to mounting apparatus, and more particularly to a mounting apparatus for mounting temperature sensors.

2. Description of Related Art

Blade and rack-mounted servers are popular in data center servers. In order to achieve high performance, many rack-mounted servers may be clustered in an enclosure. Temperature in the enclosure should be low for the servers to run smoothly. Therefore, temperature in the enclosure needs to be constantly monitored.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded and isometric view of a mounting apparatus for mounting temperature sensors.

FIG. 2 is an enlarged view of encircled portion II of FIG. 1.

FIG. 3 is an isometric view of a latch of the mounting apparatus of FIG. 1.

FIG. 4 is an isometric view of the latch of FIG. 1 and a mounting hole of FIG. 3.

FIG. 5 is an assembled view of the mounting apparatus of FIG. 1.

FIG. 6 is enlarged view of encircled portion VI of FIG. 5.

FIG. 7 is another assembled view of the mounting apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

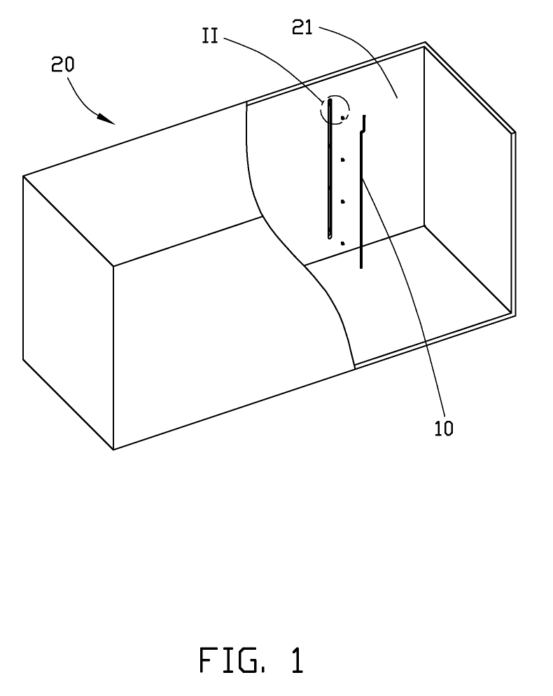

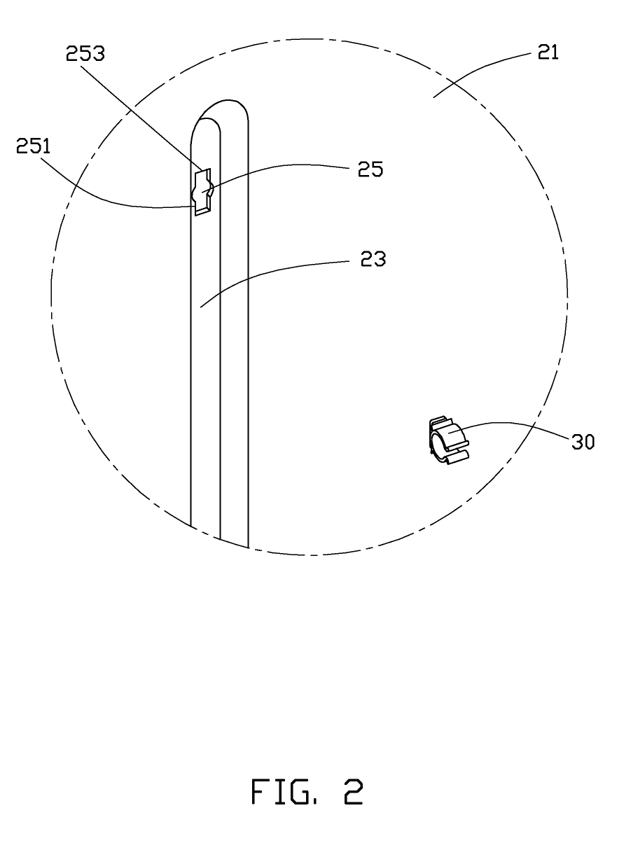

Referring to FIGS. 1 and 2, a mounting apparatus for mounting a temperature sensing apparatus 10 in accordance with an embodiment includes a plate 21 of a container 20 and a latch 30. In one embodiment, the temperature sensing apparatus 10 is a flexible wire and includes a plurality of temperature sensors placed and held in the flexible wire.

A potion of the plate 21 is recessed to define a receiving groove 23. A mounting hole 25 is defined in the receiving groove 23. The mounting hole 25 extends through the plate 21. The mounting hole 25 is substantially rectangular and includes a pair of long sides 251 and a pair of short sides 253 which are perpendicular to the pair of long sides 251. An extending direction of each of the pair of long sides 251 is the same as the extending direction of the receiving groove 23.

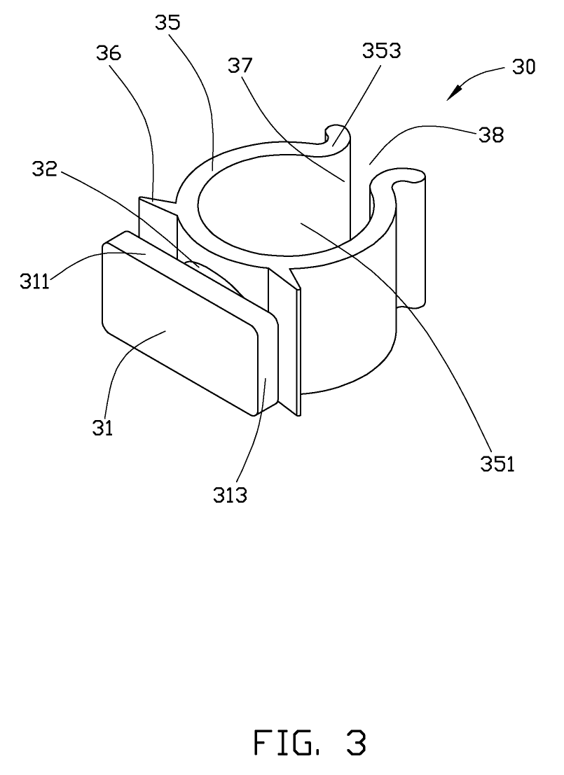

Referring to FIG. 3, the latch 30 includes a mounting base 31, a connection portion 32, and an elastic piece 35. The connection portion 32 is connected between the mounting base 31 and the elastic piece 35. The mounting base 31 is a block, which includes a pair of long edges 311 and a pair of short edges 313 which are perpendicular to the pair of long edges 311. A length of each of the pair of long edges 311 is slightly smaller than that of each of the pair of long sides 251 of the mounting hole 25, but larger than that of each of the pair short sides 253. A length of each of the pair of short edges 313 is slightly smaller than that of each of the pair of short sides 253. The elastic piece 35 is shaped in an arc and surrounds a receiving room 351 therein. A middle portion of the elastic piece 35 is connected to the connection portion 32. A pair of blocking pieces 36 is connected to the middle portion of the elastic piece 35. The elastic piece 35 includes a pair of distal ends 353. A guiding portion 37, extending outwards, is formed at each of the pair of distal ends 353. An opening 38 is defined between the pair of distal ends 353. The opening 38 communicates with the receiving room 351.

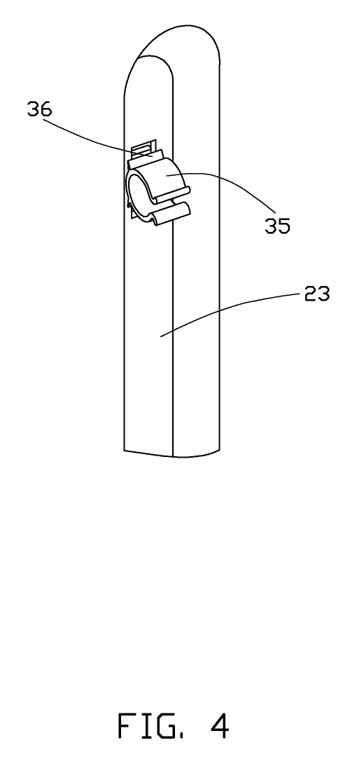

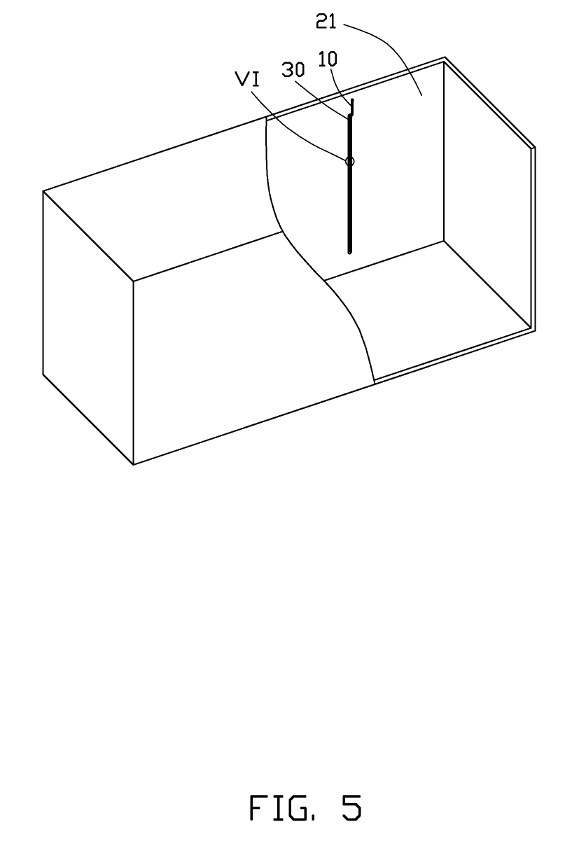

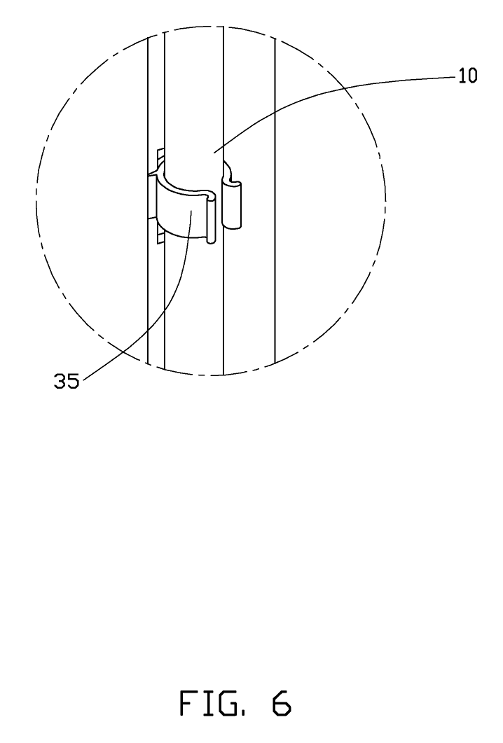

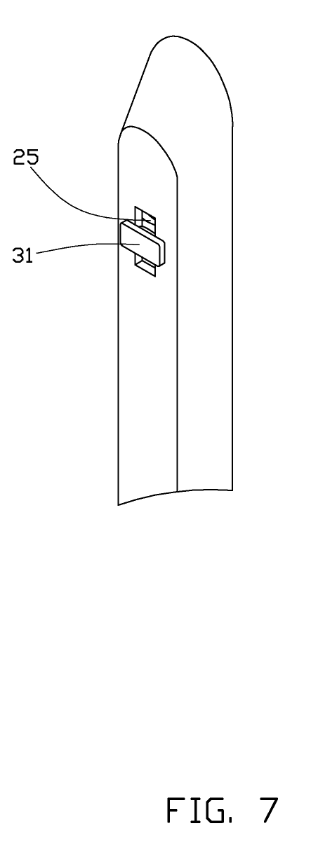

Referring to FIGS. 1 to 7, to mount the temperature sensing apparatus 10 in the container 20, the mounting base 31 of the latch 30 is aligned to the mounting hole 25 of the plate 21. Each of the pair of long edges 311 of the mounting base 31 is aligned to each of the pair of long sides 251 of the mounting hole 25, and each of the pair of short edges 313 of the mounting base 31 is aligned to each of the pair of short sides 253 of the mounting hole 25. The mounting base 31 extends through the mounting hole 25 with the connection portion 32 being received in the mounting hole 25. At this position, the blocking pieces 36 of the latch 30 abut the plate 21. Then, the latch 30 is rotated by hand 90 degrees in the mounting hole 25 to mount and secure the latch 30 in the receiving groove 23 of the plate 21.

The temperature sensing apparatus 10 is clipped into each of the openings 38. As the temperature sensing apparatus 10 comes into contact with the guiding portions 37 of the latch 30, the distal ends 353 are elastically bent outwards to accommodate the temperature sensing apparatus 10. The temperature sensing apparatus 10 enter the receiving rooms 351 via the openings 38, and the distal ends 353 rebounds to restrain and hold the temperature sensing apparatus 10 captive in the receiving room 351. Thereby, the temperature sensing apparatus 10 is secured on the plate 21 and located in the receiving groove 23 of the plate 21. Because the temperature sensing apparatus 10 is placed in the receiving groove 23, the temperature sensing apparatus 10 does not protrude into the open space within the container 20 and the temperature sensing apparatus 10 is protected from damage.

To detach the temperature sensing apparatus 10, the distal ends 353 are elastically bent to broaden the opening 38, and the temperature sensing apparatus 10 can be detached from the latch 30.

To detach the latch 30, the latch 30 is rotated back 90 degrees in the mounting hole 25 to align each of the pair of long edges 311 with each of the pair of long sides 251 and each of the pair of short edges 313 with each of the pair of short sides 253. The latch 30 then can be detached from the plate 21.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A mounting apparatus for mounting a temperature sensing apparatus, comprising:
a plate, the plate defining a mounting hole, a profile of the mounting hole being defined by a pair of long sides and a pair of short sides; and
a latch comprising a mounting base and an elastic piece, the mounting base comprising a pair of long edges and a pair of short edges, a length of each of the pair of long edges being smaller than a length of each of the pair of long sides and larger than a length of each of the pair of short sides, a length of each of the pair of short edges being smaller than the length of each of the pair of short sides;
wherein the pair of long edges are aligned to the pair of long sides, the pair of short edges are aligned to the pair of short sides, the latch is mounted on the plate by inserting the mounting base through the mounting hole and rotating the mounting base to misalign the pair of long edges with the pair of long sides, the elastic piece is configured to secure a temperature sensing apparatus.

2. The mounting apparatus of claim 1, wherein the plate defines a receiving groove, the mounting hole is defined in the receiving groove, and the latch is located in the receiving groove.

3. The mounting apparatus of claim 2, wherein the receiving groove is configured to receive the temperature sensing apparatus therein.

4. The mounting apparatus of claim 1, wherein the latch comprises a connection portion which is connected between the mounting base and the elastic piece.

5. The mounting apparatus of claim 4, wherein the elastic piece is arc shaped and a receiving room is defined by the arc-shaped elastic piece, and the temperature sensing apparatus is secured in the receiving room.

6. The mounting apparatus of claim 5, wherein a middle portion of the elastic piece is connected on the connection portion, a pair of blocking pieces are connected to the middle portion of the elastic piece, and the pair of blocking pieces abut the plate.

7. The mounting apparatus of claim 5, wherein the elastic piece comprises a pair of distal ends, an opening is defined between the pair of distal ends, and the opening communicates with the receiving room.

8. The mounting apparatus of claim 7, wherein a pair of guiding portions are formed by bending the pair of distal ends away from each other, and the pair of guiding portions are configured to guide the temperature sensing apparatus to slide into the receiving room via the opening.

9. An assembly, comprising:
a plate defining a receiving groove;
a temperature sensing apparatus placed in the receiving groove; and
a latch mounted in the receiving groove, the latch comprising an elastic piece, a receiving room defined by the elastic piece, wherein the elastic piece comprises a pair of distal ends, an opening is defined between the pair of distal ends, the opening communicates with the receiving room, a pair of guiding portions are formed by bending the pair of distal ends bent away from each other, and the pair of guiding portions are configured to guide the temperature sensing apparatus to slide into the receiving room via the opening.

10. The assembly of claim 9, wherein a mounting hole is defined in the receiving groove, a profile of the mounting hole is defined by a pair of long sides and a pair of short sides; the latch comprises a mounting base, the mounting base comprises a pair of long edges and a pair of short edges, a length of each of the pair of long edges is smaller than a length of each of the pair of long sides and larger than a length of each of the pair of short sides, a length of each of the pair of short edges is smaller than the length of each of the pair of short sides; the pair of long edges are aligned to the pair of long sides, the pair of short edges are aligned to the pair of short sides, the latch is mounted on the plate by inserting the mounting base through the mounting hole and rotating the mounting base to misalign the pair of long edges with the pair of long sides.

11. The assembly of claim 10, wherein latch comprises a connection portion which is connected between the mounting base and the elastic piece.

12. The assembly of claim 11, wherein a middle portion of the elastic piece is connected on the connection portion, a pair of blocking pieces are connected to the middle portion of the elastic piece, and the pair of blocking pieces abut the plate.
